(19) United States
(12) Patent Application Publication
(10) Pub. No.: US 2006/0213303 A1
(43) Pub. Date: Sep. 28, 2006

(54) Gear system

(75) Inventors: Takao Shigemi, Kurashiki-shi (JP); Tetsushi Isozaki, Kurashiki-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 11/377,836

(22) Filed: Mar. 17, 2006

(30) Foreign Application Priority Data
Mar. 24, 2005 (JP) 2005-087030

(51) Int. Cl. F16H 57/04

(52) U.S. Cl. 74/467; 277/354

(57) ABSTRACT

The gear system has a lubricant A put into an inner part of an oil seal provided around an input shaft, and a lubricant B put into an inner part of the reducer (gear system) which mainly lubricates a reducer portion. The characteristics of these lubricants A and B are set in such a manner that a base oil viscosity of the lubricant A is smaller than that of the latter lubricant B and a cone penetration of the lubricant A is larger than that of the lubricant B.

### BACKGROUND OF THE INVENTION

1. Field of the Invention

The present invention relates to a gear system that changes a speed of rotation input thereto and outputs the rotation having the changed speed.

2. Description of the Related Art

Conventionally, it is generally and widely performed to put a lubricant such as oil and grease into an inner part of a gear system such as a reducer so as to lubricate and cool respective components forming the inner part of the gear system.

FIG. 4 shows a reducer 20 described in the publication of Japanese Patent No. 2733448. As shown in FIG. 4, the reducer 20 is arranged in such a manner that a power is transmitted between a motor 10 and the reducer 20 via a shaft 22 rotating between them. Thus, an oil seal 28 is provided in order to prevent a lubricant put into an inner part 26 of the reducer 20 from leaking from a clearance between the shaft 22 and a casing 24 of the reducer 20.

Moreover, a technique related to the oil seal 28 is also disclosed, which puts a lubricant having a large viscosity such as grease into the oil seal 28 so as to achieve a lubrication action and prevent leak of the lubricant in the reducer toward the motor.

In the market, it is demanded to suppress a noise generated during an operation of a reducer even if only slightly. In addition, a reducer that can make its energy efficiency as high as possible and can have a low driving loss is also demanded.

The reducer 20 described as an exemplary conventional reducer did not take the problems of the noise and the driving loss into consideration.

### SUMMARY OF THE INVENTION

In view of the foregoing problems, various exemplary embodiments of this invention provide a gear system that can reduce a driving loss as a whole and can overcome a noise problem.

According to the present invention, a gear system includes: an input shaft; a transmission unit that changes a speed of rotation of the input shaft; and an output shaft that outputs the rotation having the changed speed, wherein the input shaft is provided with an oil seal portion, a base oil viscosity of a lubricant in the oil seal portion is smaller than that of a lubricant in the transmission unit, and a cone penetration of the lubricant in the oil seal portion is larger than that of the lubricant in the transmission unit.

Due to this, it is possible to effectively keep a balance between noise reduction and reduction of a driving loss in the gear system (described later).

The base oil viscosity described above shall mean a kinetic viscosity that represents a ratio of a fluid viscosity to a density of the fluid. The cone penetration shall mean a value obtained by multiplying a depth (mm) of penetration of a cone defined by JIS (Japanese Industrial Standard) into a sample in a defined time period by 10 and represent apparent hardness of grease.

The “oil seal portion” shall include the oil seal and an inner part thereof.

It is possible to supply a low-noise gear system having a low driving loss by applying the present invention.

### BRIEF DESCRIPTION OF THE DRAWINGS

FIG. 1A is a partially developed cross-sectional side view of a geared motor GM100 including a reducer according to an exemplary embodiment of the present invention;

FIG. 1B is a partially developed cross-sectional plan view of the geared motor GM100 including the reducer according to the exemplary embodiment of the present invention;

FIG. 2A is an enlarged view of a portion around a point shown with Arrow IIA in FIG. 1A;

FIG. 2B shows another exemplary oil seal and corresponds to FIG. 2A;

FIG. 2C shows another exemplary oil seal and corresponds to FIG. 2A;

FIG. 2D shows another exemplary oil seal and corresponds to FIG. 2A;

FIG. 3A is a graph showing the relationship between a base oil viscosity and a tensile load (sliding loss);

FIG. 3B is a graph showing a relationship between the base oil viscosity and a noise; and

FIG. 4 shows a conventional reducer described in the publication of Japanese Patent No. 2733448.

### DETAILED DESCRIPTION OF THE PREFERRED EMBODIMENTS

An exemplary embodiment of the present invention will now be described in detail, with reference to the drawings.

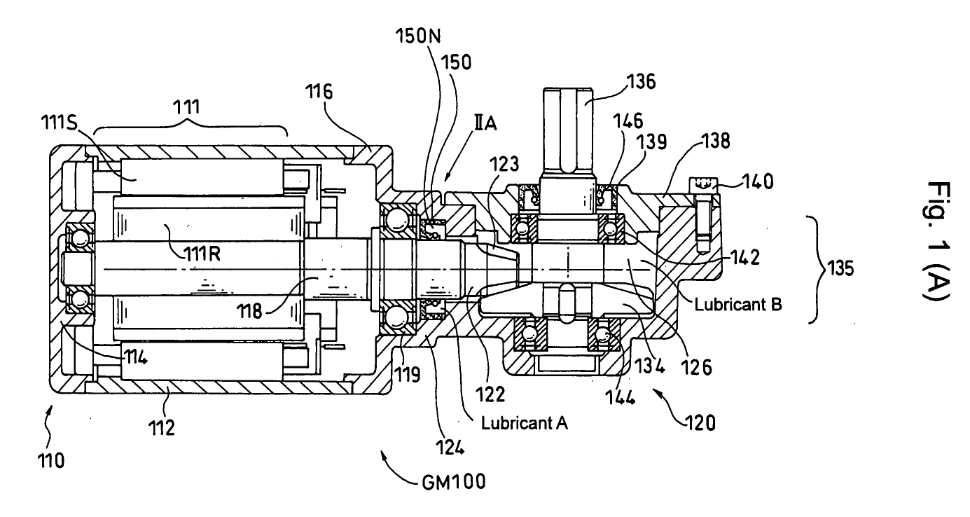

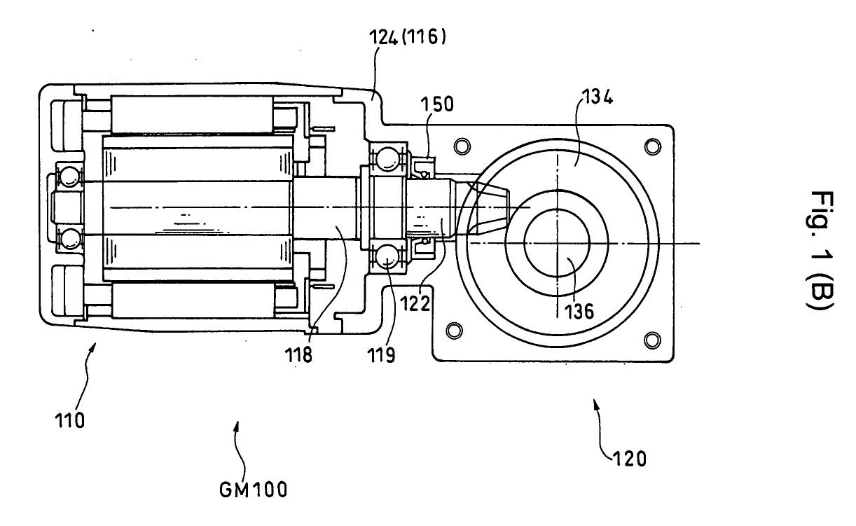

FIG. 1A is a partially developed cross-sectional side view of a geared motor GM100 including a reducer (gear system) 120 according to an exemplary embodiment of the present invention. FIG. 1B is a partially developed cross-sectional plan view thereof.

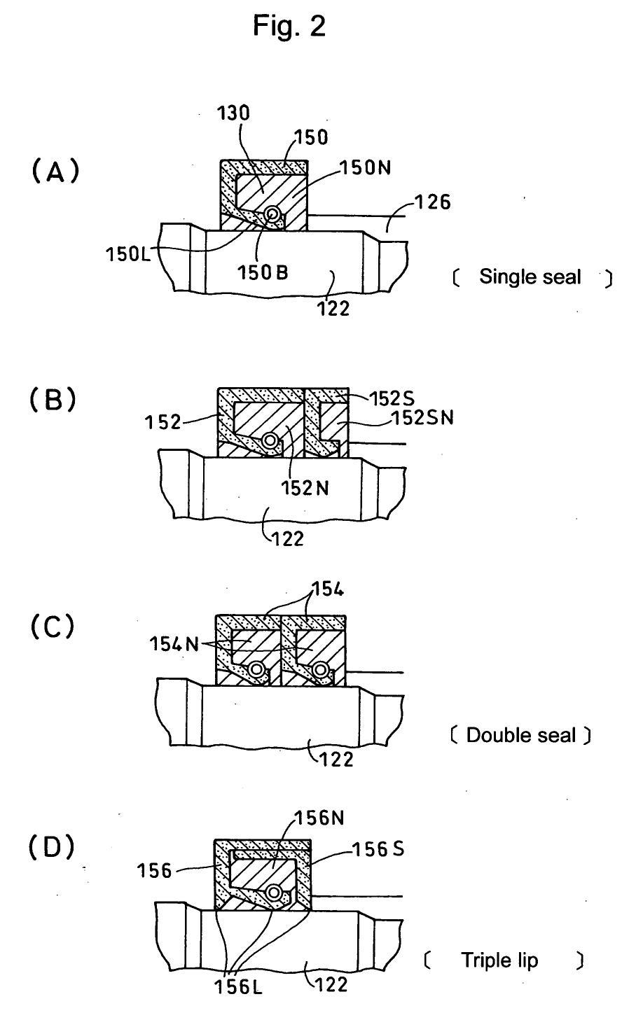

FIG. 2A is an enlarged view of a portion around a point shown with Arrow IIA in FIG. 1A.

The geared motor GM100 is formed by jointing a motor 110 to the reducer 120 with a bolt or the like (not shown) to form as one unit.

The motor 110 includes a motor driving unit 111 and a casing accommodating the driving unit 111 therein. The casing is formed by a motor casing body 112, an end cover 114, and a front cover 116. The motor driving unit 111 mainly includes a stator 111S fixed to the motor casing body 112 and a rotor 111R. Rotation of the rotor 111R can be transmitted to a motor shaft 118. The motor shaft 118 is rotatably arranged approximately at the center of the motor 110 and can transmit a driving force of the motor driving unit 111 to the outside of the motor.

The front cover 116 serving as a part of the casing of the motor 110 is formed integrally with a reducer casing body 124 of the reducer 120 described later.

An input shaft 122 integrated with the motor shaft 118, a reducer unit (transmission unit) 135, and an output shaft 136 are accommodated in the reducer casing body 124 and form the reducer 120 as a whole.

A bearing 119 is provided at the portion of the reducer casing body 124 closest to the motor 110 and supports the input shaft 122 to be freely rotatable. In the present exemplary embodiment, the input shaft 122 is formed integrally with the motor shaft 118 as one component. However, the input shaft 122 may be formed as a separate component from the motor shaft 118.

An oil seal 150 is provided around the input shaft 122 alongside of the bearing 119 and is arranged to prevent a lubricant (described in detail later) that is put into an inner part 126 of the reducer 120 from leaking toward the motor 110. The oil seal 150 is provided with a spring 150B for bringing a lip portion 150L into a close contact with the input shaft 122 (see FIG. 2A).

A hypoid pinion 123 is formed at a top end of the input shaft 122 by directly cutting the input shaft 122 and engages with a hypoid gear 134. The hypoid pinion 123 and the hypoid gear 134 form the reducer portion 135 together.

The hypoid gear 134 has a doughnut shape. An output shaft 136 for transmitting the rotation having the reduced speed to the outside is inserted and fitted into a center of the hypoid gear 134 so as to be integrated with the hypoid gear 134. The reason why the hypoid gear set is provided in the reducer portion 135 will be described later.

A cover 138 having a hole 139 is provided above the reducer portion 135 and is fixed to the reducer casing body 124 with a bolt 140.

A bearing 142 is provided in the hole 139. The bearing 142 and a bearing 144 arranged below the hypoid gear 134 support the output shaft 136 together, as shown in FIG. 1A. A part of the output shaft 136 runs through the hole 139 of the cover 138 and is exposed to the outside.

An oil seal 146 is provided above the bearing 142 provided in the hole 139, as shown in FIG. 1A.

The lubricant used in the reducer 120 will now be described.

The reducer 120 uses a lubricant A put into an inner part 150N of the oil seal 150 that seals a circumference of the input shaft 122 and a lubricant B put into an inner part 126 of the reducer 120. The lubricant B mainly lubricates and cools the reducer unit 135.

The lubricant A contains any of mineral oils, synthetic hydrocarbons, esters, glycols, ethers, silicones, and fluorine oils as its base oil, and contains any of a lithium soap, a calcium soap, an aluminum soap, a sodium soap, a barium soap, an urea compound, PTFE, organic bentonite, and silica as a thickener.

The lubricant B contains any of mineral oils, synthetic hydrocarbons, esters, glycols, ethers, silicones, and fluorine oils as its base oil, and contains any of a lithium soap, a calcium soap, an aluminum soap, a sodium soap, a barium soap, a urea compound, PTFE, organic bentonite, and silica as a thickener.

When the characteristics of the lubricant A in the inner part 150N of the oil seal 150 are compared with those of the lubricant B in the reducer portion 135, the base oil viscosity of the lubricant A is always smaller than that of the lubricant B but the cone penetration of the lubricant A is larger than that of the lubricant B (i.e., the lubricant A is softer than the lubricant B). The above setting of the characteristics of the lubricants A and B is based on a finding that a noise during an operation of the reducer 120 is generated by an engaging sound of gears in the reducer portion 135 and that it is preferable that the base oil viscosity of the lubricant B used in the reducer portion 135 be large in order to suppress generation of that engaging sound. As for a driving loss of the reducer 120, the above setting is based on a finding that it is preferable that the lubricant A used in the inner part 150N of the oil seal 150 have a small base oil viscosity and a large cone penetration, considering that a transmitted torque is easily affected in the input shaft 122 in which the torque is relatively small in the entire reducer. Therefore, the lubricant A in the inner part 150N of the oil seal 150 is selected to have a smaller base oil viscosity and a larger cone penetration than the lubricant B in the reducer portion 135, thereby keeping a good balance between a low noise and a low driving loss in the entire reducer.

Thus, a lubricant softer than the lubricant B is used as the lubricant A in the inner part 150N of the oil seal 150. This can efficiently reduce the driving loss. In addition, a portion where the oil seal 150 and the input shaft 122 slide with respect to each other does not generate a sound that may cause a noise originally. Therefore, even if a lubricant having a small base oil viscosity such as the lubricant A is used, no noise problem newly occurs.

Moreover, a lubricant having a larger base oil viscosity than the lubricant A is used as the lubricant B in the reducer portion 135. Therefore, the engaging sound that may cause a noise can be effectively reduced. Furthermore, the lubricant B has a certain level of hardness, as compared with the lubricant A in the inner part 150N of the oil seal 150. Therefore, it is possible to reduce a possibility that the lubricant B flows toward the oil seal 150 with a high pressure during an operation.

The reason why the hypoid gear set is used in the reducer portion 135 in the present exemplary embodiment is to achieve a good balance between noise reduction and reduction of a driving loss.

A structure using a worm gear set is known as an exemplary structure that is effective to reduce a noise. However, in the present exemplary embodiment, the lubricant B used in the reducer portion 135 has a large base oil viscosity. A lubricant having a large base oil viscosity tends to make a driving loss larger. Especially, in the case of using the worm gear set, the worm gear set has a large sliding resistance and therefore the driving loss significantly becomes larger because of a synergy effect of the large sliding resistance and the large base oil viscosity. In many cases, this rapid increase of the driving loss can easily cancel out an effect obtained by the use of the lubricant A having a small base oil viscosity in the inner part 150N of the oil seal 150 and is not preferable. On the other hand, in the case of using the hypoid gear set, a generated noise is basically lower (as compared with the case of using a bevel gear set and the like) and the driving loss does not increase so much even when the lubricant B has a large base oil viscosity. Therefore, the use of the hypoid gear set is preferable.

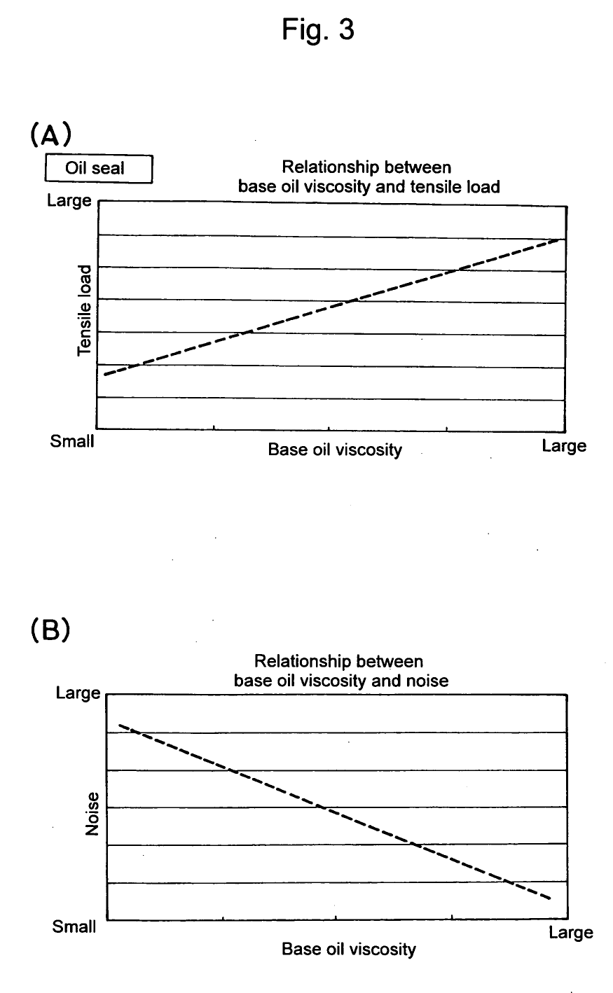

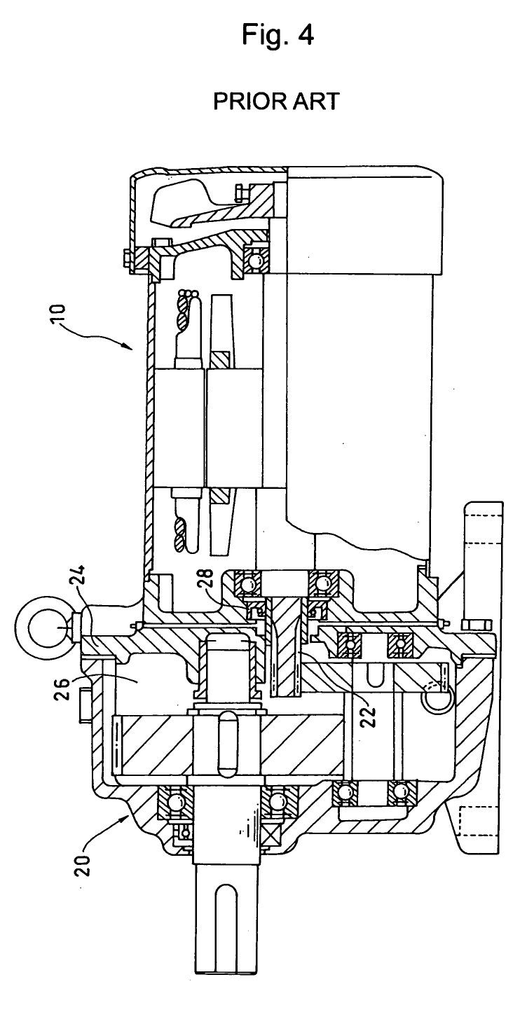

As more ideal characteristics, it is preferable that the lubricant A have a base oil viscosity of 100 mm²/s (at 40° C.) or less and a cone penetration of 400 or more. This is because the lubricant A having the above base oil viscosity and cone penetration can reduce a sliding loss (tensile load) in the oil seal portion to an acceptable level, considering a tendency that the sliding loss becomes smaller as the base oil viscosity is smaller, as shown in FIG. 3A.

However, the aforementioned relationships of the base oil viscosity and cone penetration between the lubricants A and B should also be satisfied in this case.

The reason why the above ranges of the base oil viscosity and cone penetration are preferable is because, when the base oil viscosity and the cone penetration of the lubricant A are out of the above ranges, effective loss reduction is not always achieved even if the lubricant A has a smaller base oil viscosity and a larger cone penetration than the lubricant B, for example, in the case where the present invention is applied to a large-sized reducer.

On the other hand, it is preferable that the lubricant B have a base oil viscosity of 40 mm²/s (at 40° C.) or more and a cone penetration of 430 or less. This is because the lubricant B having the above base oil viscosity and cone penetration can reduce a noise in the reducer portion to an acceptable level, considering a tendency that the generated noise becomes less louder as the base oil viscosity is larger, as shown in FIG. 3B.

However, the aforementioned relationships of the base oil viscosity and cone penetration between the lubricants A and B should also be satisfied in this case.

The reason why the above ranges of the base oil viscosity and cone penetration of the lubricant B are preferable is that, when the base oil viscosity and cone penetration of the lubricant B are out of the above ranges, effective noise reduction is not always achieved even if the lubricant B has a larger base oil viscosity and a smaller cone penetration than the lubricant A, for example, in the case where the present invention is applied to a compact reducer.

Next, an operation of the geared motor GM100 including the reducer 120 will be described.

When the motor 110 is energized, the motor shaft 118 is rotated by an action of the motor driving unit 111. The rotation of the motor shaft 118 is transmitted to the input shaft 122 of the reducer that is integrally formed with the motor shaft 118, thereby rotating the hypoid gear 134 via the hypoid pinion 123 provided at the top end of the input shaft 122. Because the hypoid pinion 123 engages with the hypoid gear 134 perpendicularly, the rotation of the input shaft 122 is turned around by 90 degrees and is output to the output shaft 136. The rotation of the output shaft 136 is transmitted to another machine (not shown).

The geared motor operating in the aforementioned manner generates a noise (mainly an engaging sound) in the reducer portion 135 in which the gears engage with each other. However, the inner part 126 of the reducer 120 is filled with the lubricant B having a larger base oil viscosity and a smaller cone penetration, as described above. Therefore, the noise level is suppressed to be low.

On the other hand, the inner part 150N of the oil seal 150 provided around the input shaft 122 is filled with the lubricant A having a smaller base oil viscosity and a larger cone penetration. Therefore, the loss in the sliding of the oil seal 150 and the input shaft 122 with respect to each other can be suppressed. More specifically, a driving torque of the input shaft 122 is relatively small in the entire reducer 120 and therefore is easily affected by the base oil viscosity and the cone penetration of the used lubricant. Thus, the lubricant A having a smaller base oil viscosity and a larger cone penetration is used, thereby reducing the driving loss in the entire reducer.

Incidentally, a lubricant in the oil seal 146 provided for the output shaft 136 is not specifically limited in the present invention because circumstances of the output shaft 136 are different from those of the input shaft 122.

As described above, a lubricant having a small base oil viscosity and a large cone penetration is used in the oil seal portion that hardly generates a noise, whereas a lubricant having a large base oil viscosity and a small cone penetration is used in the reducer portion that can easily generate a noise. In this manner, a low-noise reducer (geared motor) having a low driving loss can be achieved.

The above description is made based on the assumption that the oil seal 150 has a so-called single seal structure, as shown in FIG. 2A. However, the structure of the oil seal 150 is not limited thereto. For example, an auxiliary oil seal 152S that does not include an auxiliary lip and a spring may be provided, as shown in FIG. 2B. In this case, a base oil viscosity and a cone penetration of a lubricant put into an inner part 152N of an oil seal 152 may be appropriately changed from those of a lubricant put into an inner part 152SN of the auxiliary oil seal 152S. For example, the lubricant put into the inner part 152N of the oil seal 152 may have a smaller base oil viscosity and a larger cone penetration. In addition, a clearance may be provided between the oil seal 152 and the auxiliary oil seal 152S. Alternatively, two oil seals 154 are arranged to form a double seal structure, as shown in FIG. 2C. In this case, the characteristics of lubricants put into respective inner parts 154N of the two oil seals 154 may be made different from each other. In this manner, the driving loss can be further reduced, while leak of the lubricant can be prevented. Moreover, a clearance may be provided between the oil seals 154. Alternatively, a triple lip structure having three lip portions 156L may be employed in which an auxiliary lip 156S is provided inside an oil seal 156, as shown in FIG. 2D. In this case, even if a lubricant having a small base oil viscosity and a large cone penetration is used, it is possible to prevent oil leak from the oil seal portion more surely.

As described above, the effects of the present invention are enhanced when the present invention is applied to a reducer using a hypoid gear set. However, the reducer to which the present invention can be applied is not limited to that type.

The present invention is described based on an example in which it is applied to a reducer including a single-stage reducer portion. However, the present invention can also be applied to a multiple-stage reducer that includes more engaging portions.

The present invention can be applied not only to a reducer but also to other gear systems such as a speed-up gear.

The disclosure of Japanese Patent Application No. 2005-87030 filed Mar. 24, 2005 including specification, drawing and claim are incorporated herein by reference in its entirety.

What is claimed is:

1. A gear system comprising:
an input shaft;
a transmission unit that changes a speed of rotation of the input shaft;
an output shaft that outputs the rotation having the changed speed; and
an oil seal portion provided around the input shaft, wherein;
a base oil viscosity of a lubricant in the oil seal portion is smaller than that of a lubricant in the transmission unit; and
a cone penetration of the lubricant in the oil seal portion is larger than that of the lubricant in the transmission unit.

2. The gear system according to claim 1, wherein a hypoid gear is integrally formed with the input shaft.

3. The gear system according to claim 1, wherein the base oil viscosity of the lubricant in the oil seal portion is 100 mm²/s or less.

4. The gear system according to claim 1, wherein the base oil viscosity of the lubricant in the transmission unit is 40 mm²/s or more.

5. The gear system according to claim 1, wherein the cone penetration of the lubricant in the oil seal portion is 400 or more.

6. The gear system according to claim 1, wherein the cone penetration of the lubricant in the transmission unit is 430 or less.

7. A method of running a gear system, the gear system comprising an input shaft, a transmission unit that changes a speed of rotation of the input shaft, an output shaft that outputs the rotation having the changed speed, and an oil seal portion provided around the input shaft, the method comprising steps of:
maintaining a first condition in which a base oil viscosity of a lubricant in the oil seal portion is smaller than that of a lubricant in the transmission unit;
maintaining a second condition in which a cone penetration of the lubricant in the oil seal portion is larger than that of the lubricant in the transmission unit; and
running the gear system under both the first and second conditions.
